(19) United States
(12) Patent Application Publication
(10) Pub. No.: US 2018/0326480 A1
(43) Pub. Date: Nov. 15, 2018

(54) ADDITIVE MANUFACTURING OF METAL OBJECTS

(71) Applicant: ADMATEC EUROPE B.V., Moergestel (NL)

(72) Inventors: Jan OPSCHOOR, Petten (NL); Louis David BERKEVELD, Petten (NL); Jacob Jan SAURWALT, Petten (NL)

(73) Assignee: ADMATEC Europe B.V., Moergestel (NL)

(21) Appl. No.: 15/774,831

(22) PCT Filed: Nov. 10, 2016
(86) PCT No.: PCT/EP2016/077281

§ 371 Date: May 9, 2018

(30) Foreign Application Priority Data
Nov. 10, 2015 (NL) 2015759

(51) Int. Cl. B22F 3/00; B33Y 10/00; B33Y 50/02; B33Y 70/00; B22F 1/00; B22F 3/10

(52) U.S. Cl. CPC B22F 3/008; B33Y 10/00; B33Y 50/02; B33Y 80/00; B22F 1/0059; B22F 3/1021; B33Y 70/00

(57) ABSTRACT

The present invention relates to a radiation-curable slurry for additive manufacturing of three-dimensional metal objects, said slurry comprising: a) 2-45 wt % of a polymerizable resin; b) 0.001-10 wt % of one or more polymerization photoinitiators; c) 55-98 wt % of metal precursor particles; with the proviso that the metal precursor is not AI₂O³ or ZrO₂. The invention further relates to an additive manufacturing method for producing a three-dimensional metal object, said method comprising building a green body of metal precursor particles using the slurry according to the invention, removing organic binder from the green body to obtain a metal precursor brown body, converting the metal precursor brown body to a metal brown body and sintering the metal brown body to obtain a three-dimensional metal object. In a third aspect, the invention relates to a three-dimensional metal object obtainable by the method of the invention.

### FIELD OF THE INVENTION

The invention relates to a an additive manufacturing method, more particularly indirect stereolithography (SLA) or dynamic light processing (DLP), for the production of three-dimensional metal objects. The invention further relates to a slurry for use in said additive manufacturing method and to three-dimensional metal objects obtainable by said additive manufacturing method.

### BACKGROUND OF THE INVENTION

Additive manufacturing (AM) is a process, usually a layer-by-layer process, of joining materials to make objects from a three-dimensional computer-aided design (CAD) data model. The applications of additive manufacturing processes have been expanding rapidly over the last 20 years. Among additive manufacturing processes are material jetting, material extrusion, direct energy deposition, sheet lamination, binder jetting, powder bed fusion and photopolymerization. These technologies can all be applied to shape ceramic or metal components, starting from (sub)micrometer-sized ceramic or metal particles.

There are basically two different categories of AM processes: (i) single-step processes (also called ‘direct’ processes), in which three-dimensional objects are fabricated in a single operation where the basic geometrical shape and the basic material properties of the intended product are achieved simultaneously and (ii) multi-step processes (also called ‘indirect’ processes), in which three-dimensional objects are fabricated in two or more steps wherein the first step typically provides the basic geometric shape and the following steps consolidate the product to the intended material properties.

The present invention concerns an indirect AM process which makes use of a sacrificial binder material to shape solid powder particles. Said binder material is obtained using photopolymerization of a polymerizable resin and a polymerization photoinitiator contained in a slurry which also contains the solid powder particles. The sacrificial binder material is removed in a subsequent ‘debinding’ treatment. Examples of the process according to the present invention are indirect stereolithography (SLA), Digital Light Processing (DLP) and Large Area Maskless Photopolymerization (LAMP).

U.S. Pat. No. 6,117,612 concerns stereolithographic resins for rapid prototyping of ceramics and metals. U.S. Pat. No. 6,117,612 discloses photo-curable ceramic resins having solids loadings in excess of 40 vol % and a viscosity of less than 3000 mPa·s and their use in multi-layer fabrication of green ceramic parts. The photo-curable resins can also contain sinterable metals.

It is essential for stereolithography of ceramics, and therefore also for metals, that the depth of cure of the resin is equal to or larger than the thickness of each layer such that the interface between the layers in sufficiently cured in order to provide the three-dimensional object with sufficient mechanical strength. Hence, the penetration depth of the radiation that is used to activate the polymerization photoinitiator must be larger than the thickness of the layer.

The technical background related to depth of cure in stereolithographic processes for the manufacture of ceramic objects is described in the prior art. In this respect, reference is made to J. Deckers et al., Additive manufacturing of ceramics: A review, J. Ceramic Sci. Tech., 5 (2014), pp 245-260, to M. L. Griffith and J. W. Halloran, Freedom fabrication of ceramics via stereolithography, J. Am. Ceram. Soc., 79 (1996), pp 2601-2608, to J. W. Halloran et al., Photopolymerization of powder suspensions for shaping ceramics, J. Eur. Ceram. Soc., 31 (2011), pp 2613-2619, and to M. L. Griffith and J. W. Halloran, Ultraviolet curing of highly loaded ceramic suspensions for stereolithography of ceramics, manuscript for the Solid Freeform Fabrication Symposium 1994. The cited prior art describes the relatively low depth of cure in highly loaded ceramic particle suspensions.

The depth of cure depends upon factors related to the photopolymerization itself, including the monomer concentration, the nature and concentration of the photoinitiator, and the dose of radiation. Factors related to the ceramic or metal powder are also important. For transparent powders, the depth of cure is largely determined by scattering of the radiation and by the volume fraction of the particles. A difference between the refractive indices of the particles and the medium carrying the particles, for example a photo-curable resin with a photoinitiator, may for example reduce the depth of cure since scattering is proportional to and is inversely proportional to the square of the difference in refractive indices. For translucent or opaque particles absorption of radiation may further reduce the depth of cure. Absorption of radiation by the particles is related to the extinction coefficient or the complex refractive index κ of the particles.

The refractive index n of photo-curable resins typically lies between 1.3 and 1.7, such as for example 1.5. Many metals have a refractive index very different from 1.5. Many metals further have a non-negligible complex refractive index. Hence, the depth of cure in highly loaded metal particle slurries is comparable to or even lower than that in highly loaded ceramic particle slurries, which limits the applicability of stereolithography or related methods for the manufacturing of three-dimensional metal objects.

Particle size and particle size distribution can also effect depth of cure. Generally speaking, smaller particles result in a lower depth of cure (see J. Deckers et al., Additive manufacturing of ceramics: A review, J. Ceramic Sci. Tech., 5 (2014), pp 245-260 and A. Badev et al., Photopolymerization kinetics of a polyether acrylate in the presence of ceramic fillers used in stereolithography, J. Photoch. Photobio. A., 222 (2011), pp 117-122). Moreover, it is known that surface roughness of particles can increase scattering. Hence, metal particles with low surface roughness and/or high sphericity are preferred. Furthermore, metal powders having a low polydispersity may be preferred. Unfortunately, metal powders meeting these characteristics are often not commercially available thereby further limiting the exploitation of additive manufacturing methods for the production of three-dimensional metal objects via stereolithography or related methods.

The present invention seeks to provide an improved method for additive manufacturing of metal objects based on stereolithography or related methods.

### SUMMARY OF THE INVENTION

The present inventors found that the above object can be met by an additive manufacturing method wherein the slurry comprises metal precursor particles and wherein a three-dimensional metal precursor object is built layer-by-layer which is subsequently converted to a three-dimensional metal object.

Accordingly, the present invention provides an additive manufacturing method for producing a three-dimensional metal object, said method comprising:
a) providing a CAD model of the three-dimensional metal object, said CAD model dividing the object in layers and the layers in voxels;
b) applying a first layer of slurry comprising metal precursor particles according to the invention as a layer to be processed onto a target surface;
c) scanning voxels of said first layer of slurry with radiation in accordance with the CAD model to cause polymerization of the polymerizable resin in the slurry to an organic binder;
d) applying a subsequent layer of slurry comprising metal precursor particles according to the invention as a layer on top of the first layer;
e) scanning voxels of said subsequent layer of slurry with radiation in accordance with the CAD model to cause polymerization of the polymerizable resin in the slurry to an organic binder;
f) repeating steps d) and e) wherein each time a subsequent layer is applied onto the previous layer to produce a green body;
g) removing the organic binder from the green body of step f) to obtain a metal precursor brown body;
h) converting the metal precursor brown body of step g) to a metal brown body;
i) sintering the metal brown body of step h) to the three-dimensional metal object.

Remarkably, the present inventors have established that many different types of metal precursors can be applied to produce a specific three-dimensional metal object. The use of metal precursor particles instead of metal particles therefore greatly improves the possibility to match refractive indices of metal precursor particles and resin and to apply metal precursor particles with lower absorbance of the radiation used. Furthermore, the availability of starting material for AM of a specific three-dimensional metal object is greatly improved.

In addition, the present inventors have found that many metal precursors have a refractive index n for radiation of a given wavelength that is closer to the refractive index of photo-curable resins than that of the corresponding metal. Moreover, many metal precursors have an extinction coefficient or complex refractive index κ that is lower than that of the corresponding metal for radiation of a given wavelength. Hence, slurries comprising such metal precursor particles have increased penetration of radiation of said wavelength and higher depth of cure as compared to slurries comprising the particles of the corresponding metal.

The present invention further provides a radiation-curable slurry for additive manufacturing of three-dimensional metal objects, said slurry comprising:
a) 2-45 wt % of a polymerizable resin;
b) 0.001-10 wt % of one or more polymerization photoinitiators;
c) 55-98 wt % of metal precursor particles;
   with the proviso that the metal precursor is not Al₂O₃ or ZrO₂.

The present invention further provides three-dimensional metal objects obtainable by the method according to the invention. Although three-dimensional metal objects can also be manufactured from a variety of metal powders using selective laser melting, the three-dimensional metal objects according to the present invention differ from those manufactured using state of the art techniques by a better performance of the object due to the stress-free and very homogeneous microstructure obtained by sintering of a body of powder that is shaped by indirect additive manufacturing techniques such as SLA, DLP or LAMP.

### Definitions

The term ‘stereolithography’, abbreviated as ‘SLA’, as used herein refers to a method to build three-dimensional metal objects through layer-by-layer curing of a radiation curable slurry comprising a polymerizable resin and metal precursor particles using irradiation controlled by Computer Aided Design (CAD) data from a computer. Although stereolithography is usually performed using UV-radiation to initiate curing of the polymerizable resin, the process of ‘stereolithography’ in the context of the present invention can also be performed using other types of radiation.

The term ‘Digital Light Processing’, abbreviated as ‘DLP’, as used herein refers to a stereolithographic method to build three-dimensional metal objects wherein each layer is patterned as a whole by exposure to radiation in the pattern of a bitmap defined by a spatial light modulator. DLP is also referred to in the art as ‘Large Area Maskless Photopolymerization’, abbreviated as ‘LAMP’. Both terms are considered interchangeable. Although DLP and LAMP are usually performed using UV-radiation to initiate curing of the polymerizable resin, the processes of ‘DLP’ and ‘LAMP in the context of the present invention can also be performed using other types of radiation.

In the context of the present invention, the terms ‘polymerization’ and ‘curing’ are considered to be synonymous and are used interchangeably. Likewise, the terms ‘polymerizable’ and ‘curable’ are considered to be synonymous and are used interchangeably.

### DETAILED DESCRIPTION

In a first aspect of the invention, a radiation-curable slurry for additive manufacturing of three-dimensional metal objects is provided, said slurry comprising:
a) 2-45 wt % of a polymerizable resin;
b) 0.001-10 wt % of one or more polymerization photoinitiators;
c) 55-98 wt % of metal precursor particles;
   with the proviso that the metal precursor is not Al₂O₃ or ZrO₂.

Al weight percentages (wt %) are based on the total weight of the slurry, unless specified otherwise.

A metal precursor in the context of the invention is a chemical component that contains one or more metal atoms and one or more non-metal atoms and/or non-metal groups and that can be converted to the corresponding metal. The one or non-metal groups can be inorganic or organic in nature.

Examples of metal precursors that can be used in the slurry are chosen from the group consisting of metal oxides, metal hydroxides, metal sulfides, metal halides, organometallic compounds, metal salts, metal hydrides, metal-containing minerals and combinations thereof.

The present inventors have found that many metal precursors have a refractive index n for radiation of a given wavelength that is closer to the refractive index of photo-curable resins than that of the corresponding metal. Moreover, many metal precursors have an extinction coefficient or complex refractive index κ that is lower than that of the corresponding metal for radiation of a given wavelength. Hence, slurries comprising such metal precursor particles have increased penetration of radiation of said wavelength and higher depth of cure as compared to slurries comprising the particles of the corresponding metal.

Moreover, the present inventors have found that many different types of metal precursors can be applied to produce a specific three-dimensional metal object which greatly improves the availability of starting material for the production of a specific three-dimensional metal object. Examples of indices of refraction n and complex indices of refraction κ of several metal precursors and corresponding metals at a wavelength 2 are given in Table 1.

TABLE 1
Index of refraction n and complex index of refraction κ at certain
wavelengths λ of several metals and metal precursors

| Metal/precursor | n | κ | λ (nm) |
|---|---|---|---|
| W | 3.23 | 2.53 | 390 |
| WO₃ | 1.67 | ~0 | |
| Mo | 3.74 | 3.59 | 667 |
| MoO₃ | 2.39 | 0.07 | 390 |
| Zn | 1.17 | 4.92 | |
| ZnO | 2.1 | ~0 | 450 |
| Mg | 0.17 | 3.43 | 390 |
| MgO | 1.76 | ~0 | 390 |
| MgSO₄•7H₂O | 1.43 | ~0 | |

In an embodiment of the invention the metal precursor particles may comprise two or more different metal precursors. The two or more metal precursors may contain the same metal atoms but combinations of two or more metal precursors containing different metal atoms are also envisaged.

The following preferred examples of metal precursors that can be used in the slurry according to the invention are not intended to limit the scope of the invention.

Examples of preferred metal oxides are chosen from the group consisting of oxides of beryllium, boron, magnesium, aluminium, silicon, scandium, titanium, vanadium, chromium, manganese, iron, cobalt, nickel, copper, zinc, germanium, yttrium, zirconium, niobium, molybdenum, hafnium, tantalum, tungsten, and the lanthanides including lanthanum, cerium, praseodymium, neodymium, samarium, and the actinides including actinium, thorium, protactinium, uranium, neptunium, plutonium and combinations thereof. In a more preferred embodiment, the metal precursor is a metal oxide chosen from the group consisting of WO₃, NiO, MoO₃, ZnO and MgO. In a very preferred embodiment, the metal precursor is a metal oxide chosen from the group consisting of WO₃ and MoO₃.

Examples of preferred metal hydroxides are chosen from the group consisting of Mg(OH)₂, 4MgCO₃.Mg(OH)₂, Al(OH)₃, Zn(OH)₂, CuCO₃.Cu(OH)₂, 2CoCO₃.3Co(OH)₂, Al(OH)(CH₃COO)₂, Al(OH)(CH₃COO)₂.H₂O and combinations thereof.

An example of a preferred metal sulfide is MoS₂. Examples of preferred metal halides are WCl₆ and ZrCl₄.

Examples of preferred organometallic compounds are chosen from the group consisting of metal carboxylates, acetates, formates, hydrates thereof and combinations thereof. In a more preferred embodiment, the metal precursor is an organometallic compound or hydrate thereof chosen from the group consisting of Mg(CH₃COO)₂, Mg(CH₃COO)₂.4H₂O, Fe(COOH)₃, Fe(COOH)₃.H₂O, Al(OH)(CH₃COO)₂, Al(OH)(CH₃COO)₂.H₂O, Cu(CH₃COO)₂, Cu(CH₃COO)₂.H₂O, Co(CH₃COO)₂, Co(CH₃COO)₂.H₂O, Co(CH₃CO)₂, Zn(CH₃COO)₂, Zn(CH₃COO)₂.2H₂O, Zn(COOH)₂, Zn(COOH)₂.2H₂O, Pb(CH₃COO)₂, Pb(CH₃COO)₂.2H₂O and combinations thereof.

Examples of preferred metal salts are chosen from the group consisting of metal carbonates, oxalates, sulphates, hydrates thereof and combinations thereof. In a more preferred embodiment, the metal salt is a metal carbonate, oxalate, sulphate or hydrate thereof chosen from the group consisting of MgCO₃, MgC₂O₄, MgC₂O₄.2H₂O, 4MgCO₃.Mg(OH)₂, MgSO₄.2H₂O, MnCO₃, MnC₂O₄, MnC₂O₄.2H₂O, NiCO₃, NiC₂O₄, NiC₂O₄.2H₂O, FeC₂O₄, FeC₂O₄.2H₂O, CuC₂O₄, CuCO₃.Cu(OH)₂, CoC₂O₄, CoC₂O₄.2H₂O, 2CoCO₃.3Co(OH)₂, ZnC₂O₄, ZnC₂O₄.2H₂O, PbC₂O₄, PbCO₃ and combinations thereof.

Preferred examples of metal hydrides are chosen from the group consisting of titanium, magnesium, zirconium, vanadium and tantalum hydrides, and combinations thereof. In a more preferred embodiment, the metal precursor is a metal hydride chosen from the group consisting of TiH₂, MgH₂ and combinations thereof.

Preferred examples of metal-containing minerals are chosen from the groups consisting of rutile, ilmenite, anatase, and leucoxene (for titanium), scheelite (tungsten), cassiterite (tin), monazite (cerium, lanthanum, thorium), zircon (zirconium hafnium and silicon), cobaltite (cobalt), chromite (chromium), bertrandite and beryl (beryllium, aluminium, silicon), uranite and pitchblende (uranium), quartz (silicon), molybdenite (molybdenum and rhenium), stibnite (antimony) and combinations thereof. The metal contained in the mineral is indicated within brackets.

The polymerizable resin comprises monomers, oligomers or combinations thereof. In a preferred embodiment, the polymerizable resin comprises radically polymerizable monomers, oligomers or combinations thereof chosen from the group consisting of acrylates, vinyl ethers, allyl ethers, maleimides, thiols and mixtures thereof. In another preferred embodiment, the polymerizable resin comprises cationically polymerizable monomers, oligomers or combinations thereof chosen from the group consisting of epoxides, vinyl ethers, allyl ethers, oxetanes and combinations thereof. Naturally, radically polymerizable resins are to be combined with one or more radical polymerization photoinitiators and cationically polymerizable resins are to be combined with one or more cationic polymerization photoinitiators.

The polymerizable resin in the slurry, once cured, is meant to act as the sacrificial organic binder glue between metal precursor particles in an intermediate three-dimensional object. The sacrificial organic binder needs to be removed from the three-dimensional object to further process it to a three-dimensional metal object. Hence, the sacrificial organic binder has to provide the intermediate three-dimensional object with sufficient strength and stability to be further processed. The stability and strength of the sacrificial organic binder that is formed after polymerization of the polymerizable resin can be increased by using cross-linking monomers and/or oligomers. Cross-linking monomers and/or oligomers have two or more reactive groups. However, increased cross-linking of the sacrificial organic binder also improves the thermal stability of the binder against degradation which is unwanted for obvious reasons. Moreover, the higher the number of cross-linking monomers and/or oligomers in the polymerizable resin, the higher the shrinkage of the organic binder, which may result in shrinkage stress leading to porosities and defects in the final three-dimensional metal object. It is within the skills of the artisan to choose the optimum concentration of cross-linking monomers and/or oligomers.

Photoinitiators for radical polymerization and cationic polymerization are well-known in the art. Reference is made to J. P. Fouassier, J. F. Rabek (ed.), Radiation Curing in Polymer Science and Technology: Photoinitiating systems, Vol. 2, Elsevier Applied Science, London and New York 1993, and to J. V. Crivello, K. Dietliker, Photoinitiators for Free Radical, Cationic & Anionic Photopolymerization, 2nd Ed., In: Surface Coating Technology, Editor: G. Bradley, Vol. III, Wiley & Sons, Chichester, 1999, for a comprehensive overview of photoinitiators. It is within the skills of the artisan to match the type of polymerizable resin, the type of radiation and the one or more photoinitiators used in the slurry.

It is important that polymerization of the slurry can be controlled when particular portions of the slurry are exposed to radiation. Furthermore, the slurry should have a certain storage stability. To this end, the slurry can further comprise 0.001-1 wt % of one or more polymerization inhibitors or stabilizers based on the total weight of the slurry, preferably 0.002-0.5 wt %. The polymerization inhibitors or stabilizers are preferably added in such an amount that the slurry is storage stable over a period of 6 months. A slurry is considered storage stable if the viscosity increase is less than 10% over a period of 6 months. Examples of suitable polymerization inhibitors or stabilizers for a radically polymerizable resin are phenols, hydroquinones, phenothiazine and TEMPO. Examples of suitable polymerization inhibitors or stabilizers for a cationically polymerizable resin are compounds containing alkaline impurities, such as amines, and/or sulfur impurities.

As explained herein before, the particle size and the particle size distribution of the metal precursor particles are important parameters since they influence, among other things, slurry viscosity, maximum particle load in the slurry, scattering of the radiation and maximum layer thickness.

One standard way of defining the particle size distribution in a sample of particles is to refer to D₁₀, D₅₀ and D₉₀ values, based on a volume distribution. D₁₀ is the particle diameter value that 10% of the population of particles lies below. D₅₀ is the particle diameter value that 50% of the population lies below and 50% of the population lies above. D₅₀ is also known as the median particle size value. D₉₀ is the particle diameter value that 90% of the population lies below. A metal precursor powder that has a wide particle size distribution will have a large difference between the D₁₀ and D₉₀ values. Likewise, a metal precursor powder that has a narrow particle size distribution will have a small difference between the D₁₀ and D₉₀ values. Particle size distributions, including D₁₀, D₅₀ and D₉₀ values, may be determined by laser diffraction, for example using a Malvern Mastersizer 3000 laser diffraction particle size analyzer.

Preferred metal precursor particles that can be used in slurry as defined herein before have a particle size distribution as determined by laser diffraction that can be characterized by D₁₀, D₅₀ and D₉₀ values of 1.7 μm, 3.0 μm and 5.1 μm, respectively, more preferably D₁₀, D₅₀ and D₉₀ values of 1.9 μm, 3.0 μm and 4.3 μm, respectively, even more preferably D₁₀, D₅₀ and D₉₀ values of 2.3 μm, 3.0 μm and 4.0 μm, respectively. Other preferred metal precursor particles that can be used in slurry as defined herein before have a particle size distribution as determined by laser diffraction that can be characterized by D₁₀, D₅₀ and D₉₀ values of 1.0 μm, 1.5 μm and 2.0 μm, respectively.

In another preferred embodiment, the metal precursor particles that can be used in the slurry as defined herein before have a low surface roughness. A low surface roughness of the metal precursor particles decreases scattering of the radiation.

In a further preferred embodiment, the metal precursor particles that can be used in the slurry as defined herein before have a sphericity factor of between 0.8 and 1.0, more preferably between 0.9 and 1.0, even more preferably between 0.95 and 1.0, most preferably between 0.97 and 1.0.

In a preferred embodiment, the metal precursor particles have a particle size distribution as determined by laser diffraction characterized in that the D₉₀ diameter of the metal precursor particles is no more than 200% greater than the D₁₀ diameter of the metal precursor particle, more preferably no more than 150% greater than D₁₀, even more preferably no more than 100% greater than D₁₀. It may be beneficial if the metal precursor particles have a narrow size distribution in which D₉₀ is no more than 75% greater than D₁₀ or no more than 50% greater than D₁₀.

For the preparation of high-strength and high-density three-dimensional metal objects, the volume fraction of metal precursor particles in the slurry must be as high as possible, since the volume fraction of metal precursor particles in the slurry also determines the volume fraction of metal precursor particles in the green body and the shrinkage of the brown body during sintering. A high volume fraction of metal precursor particles results in a high viscosity. In this respect, reference is made to J. Deckers et al., Additive manufacturing of ceramics: A review, J. Ceramic Sci. Tech., 5 (2014), pp 245-260, and to M. L. Griffith and J. W. Halloran, Ultraviolet curing of highly loaded ceramic suspensions for stereolithography of ceramics, manuscript for the Solid Freeform Fabrication Symposium 1994, describing that the viscosity of suspensions highly loaded with interacting particles is inversely proportional to the volume fraction of the particles. Naturally, a proper rheology of the slurry is required to be able to apply thin layers of the slurry onto a substrate. The inventors have found that suitable values for the volume fraction of metal precursor particles and the viscosity of the slurry are as follows.

The highest possible volume fraction for mono-disperse particles is 0.74. The volume fraction of metal precursor particles in the slurry according to the invention is preferably between 0.10 and 0.70, more preferably between 0.15 and 0.65, even more preferably between 0.30 and 0.60, and still more preferably between 0.45 and 0.55. Volume fractions of between 0.10 and about 0.35 result in green bodies having a high level of shrinkage upon cure and, after sintering, in porous three-dimensional metal objects. Volume fractions of between about 0.35 and 0.70 result in green bodies having lower shrinkage upon cure and, after sintering, in massive three-dimensional metal objects. Both massive and porous three-dimensional metal objects can have valuable applications. Hence, in a preferred embodiment, the volume fraction of metal precursor particles in the slurry according to the invention is between 0.10 and 0.35. In another preferred embodiment, the volume fraction of metal precursor particles in the slurry according to the invention is between 0.35 and 0.70.

The viscosity measured at 20° C. at a shear rate between 10 s⁻¹ and 100 s⁻¹ using a plate-plate rheometer is preferably between 0.01 and 50 Pa·s, more preferably between 0.05 and 40 Pa·s, even more preferably between 0.1 and 35 Pa·s. In a preferred embodiment the slurry has no yield point.

In a second aspect of the invention, an additive manufacturing method for producing a three-dimensional metal object is provided, said method comprising:
a) providing a CAD model of the three-dimensional metal object, said CAD model dividing the object in layers and the layers in voxels;
b) applying a first layer of slurry, as defined herein before, as a layer to be processed onto a target surface;
c) scanning voxels of said first layer of slurry with radiation in accordance with the CAD model to cause polymerization of the polymerizable resin in the slurry to an organic binder;
d) applying a subsequent layer of slurry, as defined herein before, as a layer on top of the first layer;
e) scanning voxels of said subsequent layer of slurry with radiation in accordance with the CAD model to cause polymerization of the polymerizable resin in the slurry to an organic binder;
f) repeating steps d) and e) wherein each time a subsequent layer is applied onto the previous layer to produce a green body;
g) removing the organic binder from the green body of step f) to obtain a metal precursor brown body;
h) converting the metal precursor brown body of step g) to a metal brown body;
i) sintering the metal brown body of step h) to the three-dimensional metal object.

The additive manufacturing method for producing a three-dimensional metal object is an indirect method meaning that in a first step, a sacrificial organic binder is used to shape the metal-precursor particles into a three-dimensional object comprising metal precursor particles that are held together by the organic binder and that in subsequent steps this sacrificial organic binder is removed and the three-dimensional object is further processed to obtain the intended three-dimensional metal object. The sacrificial organic binder gives the green body sufficient strength by gluing together the metal precursor particles such that the green body can be further processed.

In a preferred embodiment, the radiation used in steps c) and e) of the method is actinic radiation. Preferred types of actinic radiation are UV-radiation, visible light and IR-radiation. Preferred UV-radiation has wavelengths between 10 and 380 nm, more preferably between 250 and 350 nm. Visible light has a wavelength between 380 and 780 nm. As will be appreciated by those skilled in the art, the one or more polymerization photoinitiators in the slurry must be responsive to the type of radiation applied. It is within the skills of the artisan to match photoinitiators with the spectral output of the radiation source.

The scanning of the voxels of the slurry layers in steps c) and e) in accordance with the CAD model can be performed voxel-by-voxel with one or more scanning lasers. Hence, in an embodiment, the additive manufacturing method as defined herein before is a stereolithographic (SLA) method for producing a three-dimensional metal object wherein scanning of the voxels of the slurry layers in steps c) and e) in accordance with the CAD model is performed voxel-by-voxel.

It is also possible to perform the scanning of the voxels of the slurry layers in steps c) and e) in accordance with the CAD model by simultaneously exposing all voxels in the layer to radiation through a mask. This mask defines the pattern of the specific layer to be cured in accordance with the CAD model. Thus, in an embodiment of the invention, the scanning of the voxels of the slurry layers in steps c) and e) in accordance with the CAD model is performed by simultaneously exposing all voxels in the layer to radiation through a mask.

The scanning of the voxels of the slurry layers in steps c) and e) can also be performed by simultaneously exposing all voxels in the layer to radiation using a spatial light modulator such as a beamer or a projector. This spatial light modulator projects a radiation pattern onto the layer such that voxels are cured in accordance with the CAD model. Hence, in a preferred embodiment, the additive manufacturing method as defined herein before is a Dynamic Light Processing (DLP) method for producing a three-dimensional metal object wherein scanning of the voxels of the slurry layers in steps c) and e) is performed by simultaneously exposing all voxels in the layer to radiation.

The sacrificial organic binder is obtained by polymerization of the reactive monomers, oligomers or combinations thereof in the slurry further containing the metal precursor particles. The structure of the three-dimensional object comprising the sacrificial organic binder and the metal-precursor particles is referred to in the art as a ‘green body’ or ‘green compact’.

The structure of the three-dimensional object comprising the sacrificial organic binder, i.e. the green body, is subjected to debinding in step g) to remove the organic binder. The resulting three-dimensional object mainly consisting of the metal-precursor particles after the debinding step is referred to in the art as a ‘brown body’. The binder can be removed by heating the green body, typically to a temperature of between 90 and 600° C., more preferably between 100 and 450° C. In debinding, purely thermal as well as thermo-chemical processes may take place. The debinding step can be performed by oxidation or combustion in an oxygen containing atmosphere. Preferably, the debinding step is performed as a pyrolysis step in the absence of oxygen. The debinding step can further be performed in a protective or hydrogen containing environment. Note that the debinding in step g) can also remove at least part of the organic part of an organo-metallic metal precursor.

Before heating the green body, the green body can optionally be treated with a solvent to separate the green body from the uncured slurry and/or to extract elutable organic components from the green body. Depending on the solubility of the elutable components, this solvent can be either aqueous or organic in nature. Examples of organic solvents that can be used are acetone, trichloroethane, heptanes and ethanol.

In step h) of the method, the metal precursor brown body is converted to a metal brown body. This step can be performed using methods known in the art.

For example, reference is made to the electro-decomposition or electro-deoxidation process as described in WO99/64638A1. In this process, which is called the ‘FFC process’ in the art, a solid compound such as for example a metal oxide, is arranged in contact with a cathode in an electrolysis cell comprising a fused salt. A potential is applied between the cathode and an anode of the cell such that the compound is reduced. The inventors have unexpectedly found that this process can also be used to convert metal precursor brown bodies produced in accordance with steps a) to g) of the additive manufacturing method according to the invention to a three-dimensional metal object. Further reference is made to modifications of the ‘FFC process’ as described in WO01/62996A1, WO02/40748A1, WO03/048399A2, WO03/076690A1, WO2006/027612A2, WO2006/037999A2, WO2006/092615A1, WO2012/066299A1 and WO2014/102223A1. The principle of the ‘FFC process’ can be used to reduce brown bodies comprising oxides of beryllium, boron, magnesium, aluminium, silicon, scandium, titanium, vanadium, chromium, manganese, iron, cobalt, nickel, copper, zinc, germanium, yttrium, zirconium, niobium, molybdenum, hafnium, tantalum, tungsten, and the lanthanides including lanthanum, cerium, praseodymium, neodymium, samarium, and the actinides including actinium, thorium, protactinium, uranium, neptunium and plutonium to the corresponding metals. Pure metals may be formed by reducing a brown body comprising one type of metal oxide particles and alloys may be formed by reducing a brown body comprising particles consisting of mixtures of metal oxides containing different metal atoms.

The principle of the ‘FFC process’ can further be used to reduce brown bodies comprising oxides of several metal-containing minerals that may be found in naturally occurring sands and oxide ores including rutile, ilmenite, anatase, leucoxene, scheelite, cassiterite, monazite, zircon, cobaltite, chromite, bertrandite, beryl, uranite, pitchblende, quartz, molybdenite and stibnite.

Alternatively, brown bodies comprising metal oxide particles can be converted to the corresponding metal brown bodies by reducing the metal oxides with hydrogen gas at a temperature of between 700 and 800° C. This is the preferred route for metal oxides that volatilize at temperatures of above 800° C., such as for example MoO₃ and WO₃. Note that the debinding step and the conversion step of metal oxide brown bodies using hydrogen gas can be combined when the debinding step is also performed in a hydrogen containing atmosphere.

The conversion of brown bodies comprising metal hydride particles to the corresponding metal brown bodies can conveniently take place using a thermal step. In this respect, reference is made to the dehydride step in the well-known Hydride-Dehydride (HDH) process as described in for example U.S. Pat. No. 1,835,024 and U.S. Pat. No. 6,475,428. In this dehydride step, hydrogen is removed from for example titanium, zirconium, vanadium and tantalum hydride, by heating the hydride under high vacuum.

The conversion of brown bodies comprising metal precursor particle comprising metal hydroxides, metal salts such as metal carbonates and oxalates, and organometallic compounds such as carboxylates, acetates and formates to the corresponding metal brown bodies can conveniently take place using a two-step process. In a first step, the metal hydroxide particles, metal salt particles, and/or organometallic particles in the brown body are thermally decomposed to a metal oxide. In this respect reference is made to J. Mu and D. D. Perlmutter, Thermal decomposition of carbonates, carboxylates, oxalates, acetates, formates, and hydroxides, Thermochimica Acta, 49 (1981), pp 207-218, disclosing decomposition temperatures of metal carbonates, carboxylates, oxalates, acetates, formates, and hydroxides and the resulting metal oxides. In a second step, the brown body comprising metal oxides is converted to the corresponding metal brown body using the principle of the ‘FFC process’ as described hereinbefore or by reducing the metal oxides with hydrogen gas at a temperature of between 700 and 800° C.

The conversion of brown bodies comprising metal sulphides and/or metal halides to the corresponding metal brown bodies can also conveniently take place using a two-step process. In a first step, the metal sulphides and/or metal halides in the brown body are converted to a metal oxide, for example by heating under oxygen-rich conditions. In a second step, the brown body comprising metal oxides is converted to the corresponding metal brown body using the principle of the ‘FFC process’ as described hereinbefore or the brown body comprising metal oxides is converted to the corresponding metal brown body via reduction with hydrogen gas at a temperature of between 700 and 800° C.

In step i) of the method, the brown body is sintered to the intended three-dimensional metal object. Sintering results in compacting and solidifying of the porous structure of the brown body, whereby the body becomes smaller and gains strength. The sintered body is also referred to in the art as a ‘white body’. Sintering typically takes place at temperatures below the melting temperature of the metal or alloy. The sintering of the white body takes place in a sintering furnace, preferably at a temperature between 1000 and 2500° C. It is within the skills of the artisan to choose the appropriate sintering temperature. The sintering step may encompass more than one temperature cycle to avoid thermal shocks which may lead to breakage of the three-dimensional metal object.

In a preferred embodiment, the thickness of the first and subsequent layers of slurry is between 5 and 300 μm, more preferably between 6 and 200 μm, still more preferably between 7 and 100 μm, even more preferably between 8 and 50 μm, most preferably between 9 and 20 μm.

A third aspect of the invention concerns a three-dimensional metal object obtainable by the method as defined hereinbefore. The three-dimensional metal objects according to the present invention differ from those manufactured using state of the art techniques by a better performance of the object due to the stress-free and very homogeneous microstructure obtained by sintering of a body of powder that is shaped by indirect additive manufacturing techniques such as SLA, DLP or LAMP. In an embodiment of the invention, the metal precursor particles as defined hereinbefore only contain a single type of metal atom in which case the additive manufacturing method for producing a three-dimensional metal object results in a pure metal object. In another embodiment, the metal precursor particles as defined hereinbefore contain two or more types of metal atoms in which case the additive manufacturing method for producing a three-dimensional metal object results in an alloy object. In a further embodiment, different slurries are applied in different layers, wherein the metal precursor particles in each slurry comprise a different type of metal atoms, in which case the additive manufacturing method for producing a three-dimensional metal object results in a composite metal object comprising pure metals. In a still further embodiment, different slurries are applied in different layers, wherein the metal precursor particles in each slurry comprise two or more types of metal atoms and wherein the metal compositions of the metal precursor particles in the different slurries is not identical, in which case the additive manufacturing method for producing a three-dimensional metal object results in a composite metal object comprising different alloys in different layers. Composite three-dimensional metal objects comprising pure metals and alloys are also envisaged.

Thus, the invention has been described by reference to certain embodiments discussed above. It will be recognized that these embodiments are susceptible to various modifications and alternative forms well known to those of skill in the art.

Furthermore, for a proper understanding of this document and its claims, it is to be understood that the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

All patent and literature references cited in the present specification are hereby incorporated by reference in their entirety.

The following examples are offered for illustrative purposes only, and are not intended to limit the scope of the present invention in any way.

### EXAMPLES

### Example 1

A radiation-curable slurry for additive manufacturing was made of 10 wt % of the polymerizable resin Sartomer SR344, 0.2 wt % of Irgacure 819 photoinitiator and 89.8 wt % of tungsten oxide (WO₃) particles. The tungsten oxide had a particle size of 1.2-1.8 μm (Fisher number, HC Starck PD1113). A slurry was made using a high speed mixer. The printing was performed on an Admaflex printer, using radiation with a wavelength between 390 and 420 nm with a curing time of 20 s and a layer thickness of 10 μm.

The body was debinded and converted in a reducing, hydrogen-containing atmosphere at a top temperature of 1200° C., with a dwell period at 800° C. to convert the oxide to the tungsten metal, to obtain a porous tungsten body. Before reaching 450° C., all organic binder had disappeared from the body. Sintering occurred at a temperature of 2200° C. After sintering, a tungsten body was obtained.

### Example 2

A radiation-curable slurry for additive manufacturing was made of 12 wt % of a polymerizable resin Novachem 4008, 0.2 wt % of Irgacure 819 photoinitiator, 87.8 wt % of molybdenum oxide (MoO₃) particles. The molybdenum oxide had a particle size of 3 micron. A slurry was made using a high speed mixer. The printing was executed on a Admaflex printer using radiation with a wavelength between 390 and 420 nm with a curing time of 20 s and a layer thickness of 10 micron.

The body was debinded and converted in a reducing, hydrogen containing atmosphere at a top temperature of 1150° C. During this heating step, the temperature was gradually increased from ambient temperature to 1150° C. Before reaching 450° C., all organic binder has disappeared from the body. Between 450 and 650° C. the MoO₃ is partially reduced to MoO₂, which was reduced to Mo metal between 1000 and 1150° C. Sintering occurred at a temperature of 2100° C. After sintering, a molybdenum body was obtained.

1.-15. (canceled)

16. A radiation-curable slurry for additive manufacturing of three-dimensional metal objects, comprising:
(a) 2-45 wt % of a polymerizable resin;
(b) 0.001-10 wt % of one or more polymerization photoinitiators;
(c) 55-98 wt % of metal precursor particles, with the proviso that the metal precursor is not Al₂O₃ or ZrO₂.

17. The slurry according to claim 16, wherein the volume fraction of metal precursor particles is between 0.10 and 0.70.

18. The slurry according to claim 17, wherein the volume fraction of metal precursor particles is between 0.15 and 0.65.

19. The slurry according to claim 16, wherein the metal precursor particles comprise metal precursors selected from the group consisting of metal oxides, metal hydroxides, metal sulfides, metal halides, organometallic compounds, metal salts, metal hydrides, metal-containing minerals and combinations thereof.

20. The slurry according to claim 19, wherein the metal oxide is selected from the group consisting of oxides of beryllium, boron, magnesium, aluminium, silicon, scandium, titanium, vanadium, chromium, manganese, iron, cobalt, nickel, copper, zinc, germanium, yttrium, zirconium, niobium, molybdenum, hafnium, tantalum, tungsten, the lanthanides, the actinides, and combinations thereof.

21. The slurry according to claim 20, wherein the lanthanides comprise lanthanum, cerium, praseodymium, neodymium, or samarium, and the actinides comprise actinium, thorium, protactinium, uranium, neptunium, or plutonium.

22. The slurry according to claim 19, wherein the organometallic compound is selected from the group consisting of metal carboxylates, acetates, formates, hydrates thereof and combinations thereof.

23. The slurry according to claim 19, wherein the organometallic compound is selected from the group consisting of Mg(CH₃COO)₂, Mg(CH₃COO)₂.4H₂O, Fe(COOH)₃, Fe(COOH)₃.H₂O, Al(OH)(CH₃COO)₂, Al(OH)(CH₃COO)₂.H₂O, Cu(CH₃COO)₂, Cu(CH₃COO)₂.H₂O, Co(CH₃COO)₂, Co(CH₃COO)₂.H₂O, Co(CH₃CO)₂, Zn(CH₃COO)₂, Zn(CH₃COO)₂.2H₂O, Zn(COOH)₂, Zn(COOH)₂.2H₂O, Pb(CH₃COO)₂, Pb(CH₃COO)₂.2H₂O and combinations thereof.

24. The slurry according to claim 19, wherein the metal salt is selected from the group consisting of metal carbonates, oxalates, sulphates, hydrates thereof and combinations thereof.

25. The slurry according to claim 19, wherein the metal salt is selected from the group consisting of MgCO₃, MgC₂O₄, MgC₂O₄.2H₂O, 4MgCO₃.Mg(OH)₂, MgSO₄.2H₂O, MnCO₃, MnC₂O₄, MnC₂O₄.2H₂O, NiCO₃, NiC₂O₄, NiC₂O₄.2H₂O, FeC₂O₄, FeC₂O₄.2H₂O, CuC₂O₄, CuCO₃.Cu(OH)₂, CoC₂O₄, CoC₂O₄.2H₂O, 2CoCO₃.3Co(OH)₂, ZnC₂O₄, ZnC₂O₄.2H₂O, PbC₂O₄, PbCO₃ and combinations thereof.

26. The slurry according to claim 16, wherein the metal precursor particles have a particle size distribution as determined by laser diffraction having D₁₀, D₅₀ and D₉₀ values of 1.7 μm, 3.0 μm and 5.1 μm, respectively.

27. The slurry according to claim 26, having D₁₀, D₅₀ and D₉₀ values of 1.9 μm, 3.0 μm and 4.3 μm, respectively.

28. The slurry according to claim 16, having a viscosity measured at 20° C. at a shear rate between 10 s⁻¹ and 100 s⁻¹ using a plate-plate rheometer between 0.01 and 50 Pa·s.

29. The slurry according to claim 28, having a viscosity between 0.05 and 40 Pa·s.

30. An additive manufacturing method for producing a three-dimensional metal object, the method comprising:
(a) providing a CAD model of the three-dimensional metal object, the CAD model dividing the object in layers and the layers in voxels;
(b) applying a first layer of slurry according to claim 16 as a layer to be processed onto a target surface;
(c) scanning voxels of the first layer of slurry with radiation in accordance with the CAD model to cause polymerization of the polymerizable resin in the slurry to an organic binder;
(d) applying a subsequent layer of slurry according to claim 16 as a layer on top of the first layer;
(e) scanning voxels of the subsequent layer of slurry with radiation in accordance with the CAD model to cause polymerization of the polymerizable resin in the slurry to an organic binder;
(f) repeating steps (d) and (e) wherein each time a subsequent layer is applied onto the previous layer to produce a green body;
(g) removing the organic binder from the green body of step (f) to obtain a metal precursor brown body;
(h) converting the metal precursor brown body of step (g) to a metal brown body; and
(i) sintering the metal brown body of step (h) to the three-dimensional metal object.

31. The method according to claim 30, wherein the thickness of the first and subsequent layers of slurry is between 5 and 300 μm.

32. The method according to claim 31, wherein the radiation is selected from the group consisting of actinic types of radiation.

33. The method according to claim 32, wherein the radiation is UV-radiation.

34. The method according to claim 30, wherein the additive manufacturing method is a stereolithographic (SLA) method wherein scanning of the voxels of the slurry layers in steps (c) and (e) in accordance with the CAD model is performed voxel-by-voxel.

35. The method according to claim 30, wherein the additive manufacturing method is a Dynamic Light Processing (DLP) method wherein scanning of the voxels of the slurry layer in steps (c) and (e) is performed by simultaneously exposing all voxels in the layer to radiation.

36. The method according to claim 30, wherein the conversion of the metal precursor brown body to a metal brown body is performed using electro-deoxidation, heating, heating under vacuum, heating followed by electro-deoxidation, or reduction with hydrogen gas.

37. A three-dimensional metal object, obtainable by the method according to claim 30.
